(19) United States
(12) Patent Application Publication
(10) Pub. No.: US 2017/0169519 A1
(43) Pub. Date: Jun. 15, 2017

(54) SYSTEM AND METHOD FOR AUTOMATICALLY VERIFYING TRANSACTIONS BASED ON ELECTRONIC DOCUMENTS

(71) Applicant: Vatbox, Ltd., Herzeliya (IL)

(72) Inventors: Noam GUZMAN, Ramat Hasharon (IL); Isaac SAFT, Kfar Neter (IL)

(73) Assignee: Vatbox, Ltd., Herzeliya (IL)

(21) Appl. No.: 15/391,369

(22) Filed: Dec. 27, 2016

Related U.S. Application Data
(63) Continuation-in-part of application No. 15/361,934, filed on Nov. 28, 2016.
(60) Provisional application No. 62/307,498, filed on Mar. 13, 2016.
(60) Provisional application No. 62/260,553, filed on Nov. 29, 2015.
(60) Provisional application No. 62/261,355, filed on Dec. 1, 2015.

(51) Int. Cl. G06Q 40/00

(52) U.S. Cl. CPC G06Q 40/123

(57) ABSTRACT

A system and method for verifying a transaction based on an electronic document. The method includes analyzing the electronic document to determine at least one transaction parameter of the transaction, wherein the electronic document includes at least partially unstructured data; creating a template for the transaction, wherein the template is a structured dataset including the determined at least one transaction parameter; determining, based on the created template, at least one data source; obtaining, from the determined at least one data source, data evidencing the transaction; and determining, based on the obtained evidencing data and the created template, whether the transaction is verified.

### CROSS-REFERENCE TO RELATED APPLICATIONS

This application claims the benefit of U.S. Provisional Application No. 62/307,498 filed on Mar. 13, 2016, now pending. This application is also a continuation-in-part of U.S. patent application Ser. No. 15/361,934 filed on Nov. 28, 2016, now pending, which claims the benefit of U.S. Provisional Application No. 62/260,553 filed on Nov. 29, 2015, and of U.S. Provisional Application No. 62/261,355 filed on Dec. 1, 2015. The contents of the above-referenced applications are hereby incorporated by reference.

### TECHNICAL FIELD

The present disclosure relates generally to verifying transactions indicated in electronic documents, and more particularly to verifying transactions based on contents of electronic documents.

### BACKGROUND

Customers can place orders for services such as travel and accommodations from merchants in real-time over the web. These orders can be received and processed immediately. However, payments for the orders typically require more time to complete and, in particular, to secure the money being transferred. Therefore, merchants typically require the customer to provide assurances of payment in real-time while the order is being placed. As an example, a customer may input credit card information pursuant to a payment, and the merchant may verify the credit card information in real-time before authorizing the sale. The verification typically includes determining whether the provided information is valid (i.e., that a credit card number, expiration date, PIN code, and/or customer name match known information) by inquiring the financial institution.

Upon receiving such assurances, a purchase order may be generated for the customer. The purchase order provides evidence of the order such as, for example, a purchase price, goods and/or services ordered, and the like. Later, an invoice for the order may be generated. While the purchase order is usually used to indicate which products are requested and an estimate or offering for the price, the invoice is usually used to indicate which products were actually provided and the final price for the products. Frequently, the purchase price as demonstrated by the invoice for the order is different from the purchase price as demonstrated by the purchase order. As an example, if a guest at a hotel initially orders a 3-night stay but ends up staying a fourth night, the total price of the purchase order may reflect a different total price than that of the subsequent invoice. Cases in which the total price of the invoice is different from the total actual price of the purchase order are difficult to track, especially in large enterprises accepting many orders daily (e.g., in a large hotel chain managing hundreds or thousands of hotels in a given country). The differences may cause errors in recordkeeping for enterprises.

As businesses increasingly rely on technology to manage data related to operations such as invoice and purchase order data, suitable systems for properly managing and validating data have become crucial to success. Particularly for large businesses, the amount of data utilized daily by businesses can be overwhelming. Accordingly, manual review and validation of such data is impractical, at best. However, disparities between recordkeeping documents can cause significant problems for businesses such as, for example, failure to properly report earnings to tax authorities.

Typically, to reclaim value-added tax (VAT) paid during a transaction, evidence in the form of documentation indicating information related to the transaction (such as an invoice or receipt) must be submitted to an appropriate refund authority (e.g., a tax agency of the country refunding the VAT). If the information in the submitted documentation does not match the information submitted in the reclaim request, the request is denied and no reclaim is granted. To this end, employees of organizations often manually select and submit the required documentation for VAT reclaims in the form of electronic documents (e.g., an image file showing a scan of an invoice or receipt). This manual selection introduces potential for human error due to, for example, an employee providing incorrect information in the request and/or submitting unintended documentation (e.g., an invoice for another transaction). Existing solutions for automatically verifying transactions face challenges in utilizing electronic documents containing at least partially unstructured data

Additionally, many enterprises reimburse representatives for various expenses made on behalf of the company and/or otherwise in connection with the employee's job. For example, a company may reimburse its employee for hotel lodging utilized by the employee while on a business trip. Such enterprises typically rely on employee-submitted expense reports to determine reimbursements. These employee-submitted expense reports may be erroneous, fraudulent, or otherwise inaccurate. Such inaccurate expense reports may result in incorrect reimbursements by the company or inaccurate tax submissions. Typical solutions for verifying reimbursements require manual review of documents submitted by employees, which may be further subject to human error. Other solutions may allow for automatic verification, but typically require employees to submit data in forms having a particular structure or format.

It would therefore be advantageous to provide a solution that would overcome the deficiencies of the prior art.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” may be used herein to refer to a single embodiment or multiple embodiments of the disclosure.

Some embodiments disclosed herein include a method for verifying a transaction based on an electronic document. The method includes analyzing the electronic document to determine at least one transaction parameter of the transaction, wherein the electronic document includes at least partially unstructured data; creating a template for the transaction, wherein the template is a structured dataset including the determined at least one transaction parameter; determining, based on the created template, at least one data source; obtaining, from the determined at least one data source, data evidencing the transaction; and determining, based on the obtained evidencing data and the created template, whether the transaction is verified.

Some embodiments disclosed herein also include a non-transitory computer readable medium having stored thereon instructions for causing a processing circuitry to perform a process, the process comprising: analyzing an electronic document to determine at least one transaction parameter of a transaction, wherein the electronic document includes at least partially unstructured data; creating a template for the transaction, wherein the template is a structured dataset including the determined at least one transaction parameter; determining, based on the created template, at least one data source; obtaining, from the determined at least one data source, data evidencing the transaction; and determining, based on the obtained evidencing data and the created template, whether the transaction is verified.

Some embodiments disclosed herein also include a system for verifying a transaction based on an electronic document. The system comprises: a processing circuitry; and a memory, the memory containing instructions that, when executed by the processing circuitry, configure the system to: analyze the electronic document to determine at least one transaction parameter of the transaction, wherein the electronic document includes at least partially unstructured data; create a template for the transaction, wherein the template is a structured dataset including the determined at least one transaction parameter; determine, based on the created template, at least one data source; obtain, from the determined at least one data source, data evidencing the transaction; and determine, based on the obtained evidencing data and the created template, whether the transaction is verified.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a network diagram utilized to describe the various disclosed embodiments.

FIG. 2 is a schematic diagram of a validation system according to an embodiment.

FIG. 3 is a flowchart illustrating a method for automatically verifying transactions based on electronic documents according to an embodiment.

FIG. 4 is a flowchart illustrating a method for creating a dataset based on an electronic document according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various disclosed embodiments include a method and system for automatically verifying transactions based on electronic documents. In an embodiment, a dataset is created based on an electronic document indicating information related to a transaction. The transaction may be a transaction for which a reimbursement or value-added tax (VAT) refund is sought. A structured dataset template of transaction attributes is created based on the electronic document dataset. Based on the template, at least one data source storing data evidencing the transaction, one or more of the parties to the transaction, or both, may be determined. The data evidencing the transaction is retrieved. Based on the retrieved data, it is determined whether the transaction is verified.

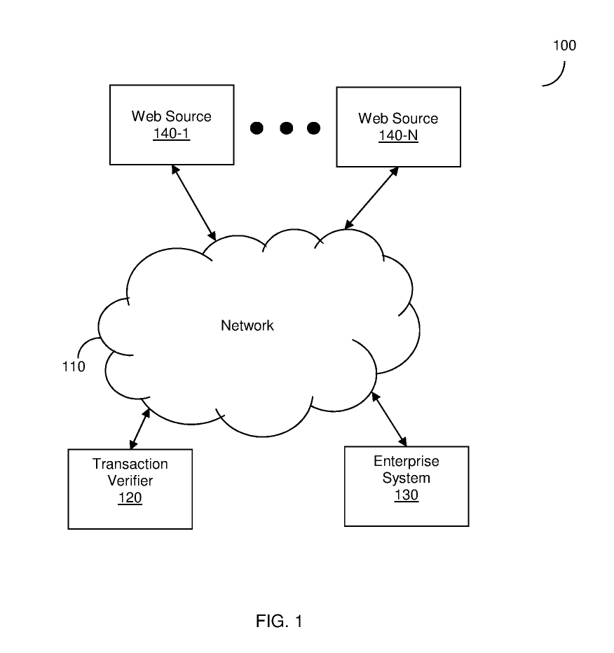

FIG. 1 shows an example network diagram 100 utilized to describe the various disclosed embodiments. In the example network diagram 100, a transaction verifier 120, an enterprise system 130, and a plurality of web sources 140-1 through 140-N (hereinafter referred to individually as a web source 140 and collectively as web sources 140, merely for simplicity purposes), are communicatively connected via a network 110. The network 110 may be, but is not limited to, a wireless, cellular or wired network, a local area network (LAN), a wide area network (WAN), a metro area network (MAN), the Internet, the worldwide web (WWW), similar networks, and any combination thereof.

The enterprise system 130 is associated with an enterprise, and may store data related to purchases made by the enterprise or representatives of the enterprise as well as data related to the enterprise itself. The enterprise system 130 may further store data related to transactions to be verified by the enterprise. The enterprise may be, but is not limited to, a business whose employees may purchase goods and services subject to VAT taxes while abroad, a business that reimburses employees for various expenses, or both. The enterprise system 130 may be, but is not limited to, a server, a database, an enterprise resource planning system, a customer relationship management system, or any other system storing relevant data.

The data stored by the enterprise system 130 may include, but is not limited to, electronic documents (e.g., an image file showing, for example, a scan of an invoice, a text file, a spreadsheet file, etc.). Each electronic document may show, e.g., an invoice, a tax receipt, a purchase number record, a VAT reclaim request, an employee expense report, and the like. Data included in each electronic document may be structured, semi-structured, unstructured, or a combination thereof. The structured or semi-structured data may be in a format that is not recognized by the transaction verifier 120 and, therefore, may be treated as unstructured data.

The web sources 140 store data evidencing transactions. Such data may include, but is not limited to, data indicating information related to the transaction (e.g., data indicating price, products purchased, tax(es), buyer, seller, etc.), data related to at least one party to a transaction (e.g., data indicating a location of one of the parties to the transaction), or both. The data evidencing transactions may further be or may include, but is not limited to, metadata. As a non-limiting example, the data used to verify a transaction may include metadata indicating a location of a user at the time of the transaction.

The web sources 140 may include, but are not limited to, servers or devices of merchants, tax authority servers, accounting servers, a database associated with an enterprise, and the like. As a non-limiting example, the web source 140-1 may be a merchant server storing data related to purchase prices for transactions made with the merchant.

In an embodiment, the transaction verifier 120 is configured to create a template based on transaction parameters identified using machine vision of an electronic document indicating information related to a transaction. In a further embodiment, the transaction verifier 120 may be configured to retrieve the electronic document from, e.g., the enterprise system 130. Based on the created template, the transaction verifier 120 is configured to retrieve data evidencing the transaction.

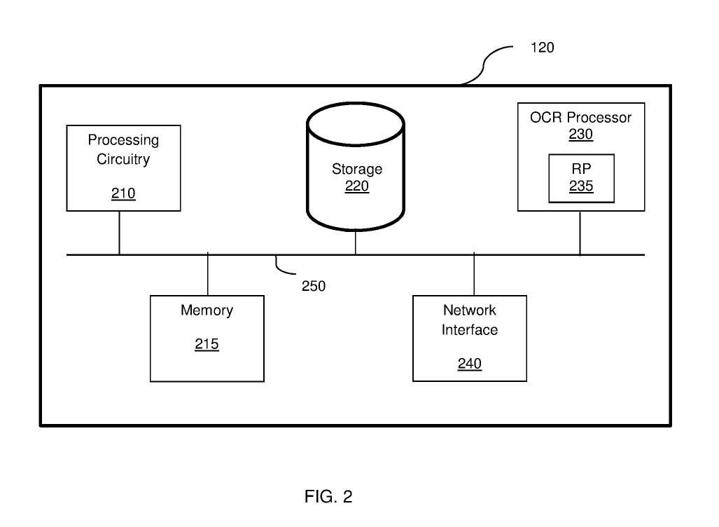

In an embodiment, the transaction verifier 120 is configured to create datasets based on electronic documents including data that is at least partially unstructured (e.g., unstructured data, semi-structured data, or structured data having an unknown structure). To this end, the transaction verifier 120 may be further configured to utilize optical character recognition (OCR) or other image processing to determine data in the electronic document. The transaction verifier 120 may therefore include or be communicatively connected to a recognition processor (e.g., the recognition processor 235, FIG. 2).

In an embodiment, the transaction verifier 120 is configured to analyze the created datasets to identify transaction parameters related to transactions indicated in the electronic documents. In an embodiment, the transaction verifier 120 is configured to create templates based on the created datasets. Each template is a structured dataset including the identified transaction parameters for a transaction.

In an embodiment, the transaction verifier 120 is configured to verify a transaction indicated in an electronic document. In a further embodiment, the transaction verifier 120 is configured to create a template for the electronic document and to obtain, based on the created template data evidencing the transaction. The evidencing data may be or may include metadata. In a further embodiment, the transaction verifier 120 is configured to determine at least one data source from which to obtain the evidencing data. The at least one data source may include, but is not limited to, the web sources 140, the enterprise system 130, or both. In yet a further embodiment, the transaction verifier 120 is configured to retrieve the evidencing data from the determined at least one data source.

Based on the evidencing data and the created template, the transaction verifier 120 is configured to determine whether the transaction indicated in the electronic document is verified. To this end, in a further embodiment, the transaction verifier 120 is configured to compare data of the created template to the obtained evidencing data. In yet a further embodiment, the comparison is further based on a structure of the template. As a non-limiting example, data in a “location” field of the template may be compared to metadata indicating a location of a user device (not shown) associated with the buyer. In another embodiment, based on the comparison, the transaction verifier 120 is configured to determine whether the compared data matches above a predetermined threshold and, if so, that the transaction is verified.

In an embodiment, when it is determined that the transaction is not verified, a cause of the failure to verify may be determined. Potential causes of failure to verify a transaction may include circumstances or assumptions related to the cause of a difference between, e.g., the template and the evidencing data. The potential causes may be determined based on one or more causation rules. In an embodiment, the causation rules may include potential causes associated with particular values for differences in price or multiples thereof. In a further embodiment, the causation rules may further be based on whether the difference is positive (e.g., a price in an invoice is higher than a price indicated by evidencing data) or negative, (e.g., a price in an invoice is lower than a price indicated by evidencing data).

As a non-limiting example for determining a cause of failure, a causation rule may include an employee expense report indicating location of a transaction that is different from a location of a user device of the buyer. Thus, a cause of the failure to verify is determined to be “incorrect employee location.” For example, when an employee expense report indicates that a purchase of a shuttle ticket was made in Greece at 5:00 PM on September 9 by an employee “John Smith” but metadata associated with the company smartphone of John Smith indicates that the smartphone was in the UK at the time 5:00 PM on September 9.

In another embodiment, a notification indicating whether the transaction is verified may be generated and sent to, e.g., the enterprise system 130. In a further embodiment, when it is determined that the transaction is not verified, the notification may further indicate the determined causes of failure.

It should be noted that the embodiments described herein above with respect to FIG. 1 are described with respect to one enterprise system 130 merely for simplicity purposes and without limitation on the disclosed embodiments. Multiple enterprise systems may be equally utilized without departing from the scope of the disclosure.

FIG. 2 is an example block diagram of the transaction verifier 120 implemented according to an embodiment. The transaction verifier 120 includes a processing circuitry 210 coupled to a memory 215, a storage 220, an optical character recognition (OCR) processor 230, and a network interface 240. In a further embodiment, the components of the transaction verifier 120 may be communicatively connected via a bus 250.

The processing circuitry 210 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), general-purpose microprocessors, microcontrollers, digital signal processors (DSPs), and the like, or any other hardware logic components that can perform calculations or other manipulations of information.

The memory 215 may be volatile (e.g., RAM, etc.), non-volatile (e.g., ROM, flash memory, etc.), or a combination thereof. In one configuration, computer readable instructions to implement one or more embodiments disclosed herein may be stored in the storage 220.

In another embodiment, the memory 215 is configured to store software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the processing circuitry 210, cause the processing circuitry 210 to perform the various processes described herein. Specifically, the instructions, when executed, cause the processing circuitry 210 to perform automatic verification of transaction based on electronic documents, as described herein.

The storage 220 may be magnetic storage, optical storage, and the like, and may be realized, for example, as flash memory or other memory technology, CD-ROM, Digital Versatile Disks (DVDs), or any other medium which can be used to store the desired information.

The OCR processor 230 may include, but is not limited to, a feature and/or pattern recognition processor (RP) 235 configured to identify patterns, features, or both, in unstructured data sets. Specifically, in an embodiment, the OCR processor 230 is configured to identify at least characters in the unstructured data. The identified characters may be utilized to create a dataset including data required for verification of a transaction.

The network interface 240 allows the transaction verifier 120 to communicate with the enterprise system 130, the web sources 140, or a combination of, for the purpose of, for example, collecting metadata, retrieving data, obtaining electronic documents, storing data, and the like.

It should be understood that the embodiments described herein are not limited to the specific architecture illustrated in FIG. 2, and other architectures may be equally used without departing from the scope of the disclosed embodiments.

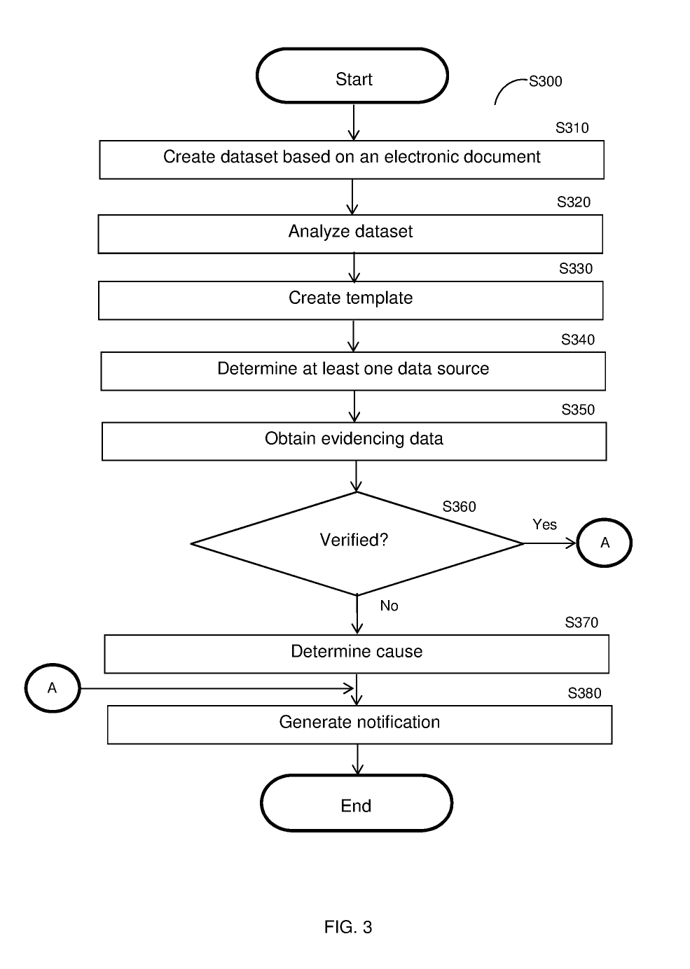

FIG. 3 is an example flowchart 300 illustrating a method for automatically verifying a transaction based on an electronic document according to an embodiment. In an embodiment, the method may be performed by a transaction verifier (e.g., the transaction verifier 120).

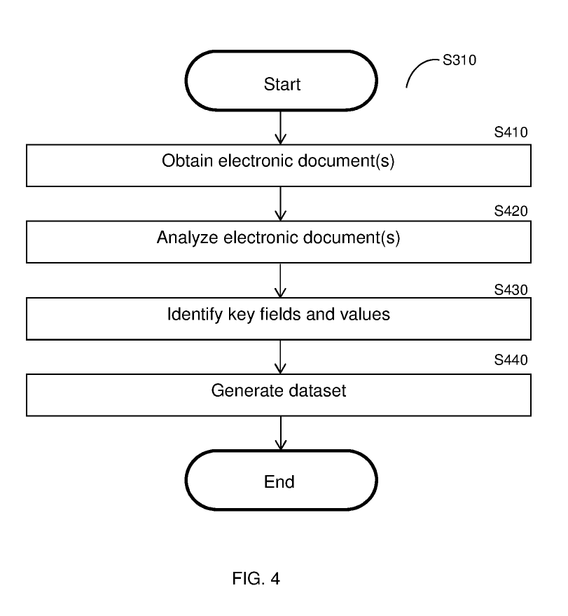

At S310, a dataset is created based on an electronic document including information related to a transaction. The electronic document may include, but is not limited to, unstructured data, semi-structured data, structured data with structure that is unanticipated or unannounced, or a combination thereof. In an embodiment, S310 may further include analyzing the electronic document using optical character recognition (OCR) to determine data in the electronic document, identifying key fields in the data, identifying values in the data, or a combination thereof. Creating datasets based on electronic documents is described further herein below with respect to FIG. 4.

At S320, the dataset is analyzed. In an embodiment, analyzing the dataset may include, but is not limited to, determining transaction parameters such as, but not limited to, at least one entity identifier (e.g., a consumer enterprise identifier, a merchant enterprise identifier, or both), information related to the transaction (e.g., a date, a time, a price, a type of good or service sold, etc.), or both. In a further embodiment, analyzing the dataset may also include identifying the transaction based on the dataset.

At S330, a template is created based on the dataset. The template may be, but is not limited to, a data structure including a plurality of fields. The fields may include the identified transaction parameters. The fields may be predefined.

Creating templates from electronic documents allows for faster processing due to the structured nature of the created templates. For example, query and manipulation operations may be performed more efficiently on structured datasets than on datasets lacking such structure. Further, organizing information from electronic documents into structured datasets, the amount of storage required for saving information contained in electronic documents may be significantly reduced. Electronic documents are often images that require more storage space than datasets containing the same information. For example, datasets representing data from 100,000 image electronic documents can be saved as data records in a text file. A size of such a text file would be significantly less than the size of the 100,000 images.

At S340, at least one data source from which data evidencing the transaction can be obtained is determined. Such a data source may include, but is not limited to, one or more web sources, an enterprise system, or both. In a further embodiment, S340 further includes determining the data source based on the template. For example, if the template includes a field “buyer” indicating a name of a person making a purchase, at least one data source storing metadata related to, e.g., user devices associated with potential buyers may be determined.

At S350, data evidencing the transaction is obtained from the determined at least one data source. In an embodiment, the data may be obtained based on the created template. As a non-limiting example, if the template includes a “location” field indicating a location of the transaction, a “time” field indicating a time of the transaction, and a “buyer” field indicating an employee who made the transaction, metadata indicating a location of a user device associated with the employee at the time of the transaction may be obtained. As another non-limiting example, if the template includes a “price” field indicating a price of the transaction and a “transaction ID” field indicating an identifier of the transaction, metadata indicating a price of the transaction may be retrieved from a merchant database.

At S360, it is determined, based on the template and the obtained evidencing data, whether the transaction is verified and, if so, execution continues with S380; otherwise, execution continues with S370. In an embodiment, S360 may include comparing data in the template to the obtained evidencing data. In another embodiment, the verification may be based further on a predetermined threshold. For example, the transaction may be verified if the compared data matches above a predetermined threshold.

In another embodiment, the comparison may be based on a structure of the template. In a further embodiment, data in each field of the template may be compared to corresponding data obtained from the at least one data source. For example, data in fields “location,” “buyer,” and “price” may be compared to corresponding location, employee, and price data, respectively, obtained from the determined at least one data source.

At optional S370, when it is determined that the transaction is not verified, at least one cause of failure to verify is determined. In an embodiment, the at least one cause of failure to verify may be determined based on at least one causation rule. The causes may include, but are not limited to, incorrect location, incorrect price, and the like.

At optional S380, a notification may be generated. The notification may indicate whether the transaction is verified. In another embodiment, when the transaction is not verified, the notification may include the determined at least one cause.

FIG. 4 is an example flowchart S310 illustrating a method for creating a dataset based on an electronic document according to an embodiment.

At S410, the electronic document is obtained. Obtaining the electronic document may include, but is not limited to, receiving the electronic document (e.g., receiving a scanned image) or retrieving the electronic document (e.g., retrieving the electronic document from a consumer enterprise system, a merchant enterprise system, or a database).

At S420, the electronic document is analyzed. The analysis may include, but is not limited to, using optical character recognition (OCR) to determine characters in the electronic document.

At S430, based on the analysis, key fields and values in the electronic document are identified. The key field may include, but are not limited to, merchant's name and address, date, currency, good or service sold, a transaction identifier, an invoice number, and so on. An electronic document may include unnecessary details that would not be considered to be key values. As an example, a logo of the merchant may not be required and, thus, is not a key value. In an embodiment, a list of key fields may be predefined, and pieces of data that may match the key fields are extracted. Then, a cleaning process is performed to ensure that the information is accurately presented. For example, if the OCR would result in a data presented as “1211212005”, the cleaning process will convert this data to Dec. 12, 2005. As another example, if a name is presented as “Mo$den”, this will change to “Mosden”. The cleaning process may be performed using external information resources, such as dictionaries, calendars, an enterprise database, and the like.

In a further embodiment, it is checked if the extracted pieces of data are completed. For example, if the merchant name can be identified but its address is missing, then the key field for the merchant address is incomplete. An attempt to complete the missing key field values is performed. This attempt may include querying external systems and databases, correlation with previously analyzed invoices, or a combination thereof. Examples for external systems and databases may include business directories, Universal Product Code (UPC) databases, parcel delivery and tracking systems, and so on. In an embodiment, S430 results in a complete set of the predefined key fields and their respective values.

At S440, a structured dataset is generated. The generated dataset includes the identified key fields and values.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; A and B in combination; B and C in combination; A and C in combination; or A, B, and C in combination.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for verifying a transaction based on an electronic document, comprising:
analyzing the electronic document to determine at least one transaction parameter of the transaction, wherein the electronic document includes at least partially unstructured data;
creating a template for the transaction, wherein the template is a structured dataset including the determined at least one transaction parameter;
determining, based on the created template, at least one data source;
obtaining, from the determined at least one data source, data evidencing the transaction; and
determining, based on the obtained evidencing data and the created template, whether the transaction is verified.

2. The method of claim 1, wherein determining whether the transaction is verified further comprises:
comparing data of the created template to corresponding evidencing data.

3. The method of claim 1, further comprising:
determining at least one cause of a failure to verify, when it is determined that the transaction is not verified.

4. The method of claim 1, wherein the obtained data includes metadata associated with a user device.

5. The method of claim 1, wherein analyzing the electronic document further comprises:
identifying, in the electronic document, at least one key field and at least one value;
creating, based on the electronic document, a dataset, wherein the created dataset includes the at least one key field and the at least one value; and
analyzing the created dataset, wherein the at least one transaction parameter is determined based on the analysis.

6. The method of claim 1, wherein identifying the at least one key field and the at least one value further comprises:
analyzing the electronic document to determine data in the electronic document; and
extracting, based on a predetermined list of key fields, at least a portion of the determined data, wherein the at least a portion of the determined data matches at least one key field of the predetermined list of key fields.

7. The method of claim 6, wherein analyzing the electronic document further comprises:
performing optical character recognition on the electronic document.

8. The method of claim 6, further comprising:
performing a cleaning process on the extracted at least a portion of the determined data.

9. The method of claim 6, further comprising:
checking if each piece of data of the extracted at least a portion of the determined data is completed; and
for each piece of data that is not completed, performing at least one of: querying at least one external source, and correlating the determine data with data of at least one previously analyzed electronic document.

10. The method of claim 1, wherein the transaction is a least a financial transaction.

11. The method of claim 11, wherein the verification is performed during at least one of: value-added tax (VAT) reclaiming and VAT auditing.

12. A non-transitory computer readable medium having stored thereon instructions for causing a processing circuitry to perform a process, the process comprising:
analyzing an electronic document to determine at least one transaction parameter of a transaction, wherein the electronic document includes at least partially unstructured data;
creating a template for the transaction, wherein the template is a structured dataset including the determined at least one transaction parameter;
determining, based on the created template, at least one data source;
obtaining, from the determined at least one data source, data evidencing the transaction; and
determining, based on the obtained evidencing data and the created template, whether the transaction is verified.

13. A system for validating a transaction represented by an electronic document, comprising:
a processing circuitry; and
a memory, the memory containing instructions that, when executed by the processing circuitry, configure the system to:
analyze the electronic document to determine at least one transaction parameter of the transaction, wherein the electronic document includes at least partially unstructured data;
create a template for the transaction, wherein the template is a structured dataset including the determined at least one transaction parameter;
determine, based on the created template, at least one data source;
obtain, from the determined at least one data source, data evidencing the transaction; and
determine, based on the obtained evidencing data and the created template, whether the transaction is verified.

14. The system of claim 13, wherein the system is further configured to:
compare data of the created template to corresponding evidencing data.

15. The system of claim 13, wherein the system is further configured to:
determine at least one cause of a failure to verify, when it is determined that the transaction is not verified.

16. The system of claim 13, wherein the obtained data includes metadata associated with a user device.

17. The system of claim 13, wherein the system is further configured to:
identify, in the electronic document, at least one key field and at least one value;
create, based on the electronic document, a dataset, wherein the created dataset includes the at least one key field and the at least one value; and
analyze the created dataset, wherein the at least one transaction parameter is determined based on the analysis.

18. The system of claim 13, wherein the system is further configured to:
analyze the electronic document to determine data in the electronic document; and
extract, based on a predetermined list of key fields, at least a portion of the determined data, wherein the at least a portion of the determined data matches at least one key field of the predetermined list of key fields.

19. The system of claim 18, wherein the system is further configured to:
perform optical character recognition on the electronic document.

20. The system of claim 18, wherein the system is further configured to:
perform a cleaning process on the extracted at least a portion of the determined data.

21. The system of claim 16, wherein the system is further configured to:
check if each piece of data of the extracted at least a portion of the determined data is completed; and
for each piece of data that is not completed, perform at least one of: query at least one external source, and correlate the determine data with data of at least one previously analyzed electronic document.

22. The system of claim 13, wherein the transaction is a least a financial transaction.

23. The system of claim 13, wherein the verification is performed during at least one of: value-added tax (VAT) reclaiming and VAT auditing.
